(19) United States
(12) Patent Application Publication
(10) Pub. No.: US 2004/0076153 A1
(43) Pub. Date: Apr. 22, 2004

(54) Infrared crosspoint system

(76) Inventor: Peter D Hallenbeck, Efland, NC (US)

Correspondence Address: MOORE & VAN ALLEN, PLLC, 2200 W MAIN STREET, SUITE 800, DURHAM, NC, 27705, US

(21) Appl. No.: 10/467,524

(22) PCT Filed: Jun. 13, 2002
(86) PCT No.: PCT/US02/18818

(51) Int. Cl. H04L 12/56

(52) U.S. Cl. 370/389; 370/252

(57) ABSTRACT

Infrared crosspoint system. An infrared (IR) command code is received at the source location, and processed to produce a packet of information representing the IR command code. This packet can be incorporated into a communication frame such as an Ethernet frame and forwarded over a network. The frame is parsed at the destination location and the IR command code can be reassembled based on information in the packet. In some embodiments, apparatus including a frequency determination buffer, an IR transmitter and receiver and a processing platform is used to implement the invention. The techniques disclosed herein can also be implemented as part of a general purpose, premises automation system, consisting of distributed processing platforms.

### DESCRIPTION

### BACKGROUND ART

Infrared light has been the preferred transmission medium for implementing “remote control” functions in home entertainment devices for more than 20 years. Pulses of infrared light are easy and inexpensive to generate, and are free from radio frequency interference. In infrared remote control, on/off pulses of light effectively transmit a type of binary code to the device that is being controlled. A significant drawback of this system is that it can only be used in a “line of sight” situation. Since light does not pass through walls and other objects, a stand-alone infrared remote control must normally be in the same room as the device to be controlled.

To overcome this line-of-sight limitation, various systems have been used to transport an infrared command code from one room to another in a residence or other building. However, these systems have been largely limited to the technique of sending an exact copy of an infrared (IR) command code from one place to another. This transmission is typically accomplished by converting the pulses to radio frequency, or to electrical pulses that exactly match the original command code, which are then sent over wiring dedicated to this purpose.

One reason that methods of transferring IR command codes across wide areas have been limited is the wide variation of coding schemes used in IR remotes. As the use of IR remote controls proliferated, manufacturers sought to prevent interference between remote controls by adopting specific coding schemes for their devices. Consequently, a pattern of pulses which initiates “play” on one manufacturers VCR is not the same as the pattern of pulses to initiate “play” on another manufacturers VCR. In addition, most remotes don't simply send out a sequence of IR on and off pulses. Rather, a baseband pattern is modulated. However, if an exact replica of the IR command code is sent as described above, proper compatibility with the receiver in the device is assured.

FIG. 1 illustrates a modulated IR carrier, 101. FIG. 1 also illustrates a baseband pulse pattern, 103, which may indicate a certain function on a certain manufacturer's remote. An IR output pulse like that shown at 103 is amplitude modulated at a specific frequency with a waveform like that shown at 101. Modulating the IR baseband pattern produces a signal with a carrier and the receiver in the device to be controlled is tuned to the carrier frequency. This technique assists the receiver in rejecting other IR signals, which are not intended to control it. A waveform for an IR command code like that shown at 105 results from this technique. Modulation frequencies are typically in the range of 36 to 40 kHz, however frequencies as high as 100 kHz have been used.

### DISCLOSURE OF INVENTION

The present invention provides a way of efficiently encoding IR command codes into a digital format that allows the codes to be moved around a premises with the same intelligence that is commonly applied to computer networking. In effect, the invention allows the creation of a distributed, infrared crosspoint system. The invention also provides for intelligent retransmission and routing of infrared command codes either in a distributed system relying on computer networking techniques, or a more limited system in which infrared command codes are analyzed and routed at a single point.

In some embodiments of the invention, an infrared (IR) command code from a remote is received at a source location by an IR receiver and sent to an IR transmitter at a destination location. The IR transmitter then emits the command code so that it can be received by the device sought to be controlled. When the IR command code is received at the source location, it is processed to produce a packet of information representing the IR command code. This packet can be incorporated into a communication frame such as an Ethernet frame and forwarded over a network. The frame is parsed at the destination location and the IR command code can be reassembled based on information in the packet. In one embodiment, the processing or encoding of the IR command code includes the extracting of the carrier frequency, the demodulating of the code to produce the baseband pattern, and the oversampling of the baseband pattern to produce a digital bitstream. An indication of the carrier frequency and the bitstream itself are used to form the information packet. Compression algorithms can be used to reduce the size of the information packet and the baseband pattern or the modulated signal can be analyzed in order to determine how to route the IR command code. In some embodiments, an Ethernet network is used to transport Ethernet frames containing the IR command code packets around a premises.

The means for implementing the various steps in the processes of the invention are varied. In some embodiments, a dedicated IR crosspoint system can be used. In such a dedicated system, apparatus would typically be installed in each location where infrared activity is expected. This apparatus would include an IR transmitter, a modulation block, a communication interface, and a processing platform operative to control the apparatus to assemble and parse communication frames containing the information packets, which define the IR command codes. The apparatus in each location can be a transmitter, a receiver, or a combination unit. If the apparatus contains an IR receiver, to receive command codes from remotes in the location, a frequency determination buffer is included in some embodiments. A demodulation block is also included. Distributed IR crosspoint apparatus can be combined with other devices, such as home entertainment devices. It is also possible to implement the invention in a single location, with a single piece of processor controlled hardware. In this case, only the IR transmitters and IR receivers would be distributed around the premises. In such a case, the common processing platform would perform all of the processing. This processing might include dynamic, intelligent routing based on the contents of the IR command code information packet or the source of the command code, as well as on stored routing information.

The techniques disclosed herein can also be implemented as part of a general purpose, premises automation system. In this case, at least some of the apparatus of this system is equipped with IR transmitters and receivers, frequency determination buffers if necessary, and computer program or “microcode” that performs the encapsulating, parsing, routing, and other functions necessary to carry out the methods of the invention.

### BRIEF DESCRIPTION OF DRAWINGS

FIG. 1 shows waveform diagrams, which illustrate the format of infrared (IR) command codes.

FIG. 2 is a flowchart which illustrates the method of receiving an IR command code at a source location, and processing the code to produce an information packet that can then be encapsulated in a communication frame.

FIG. 3 is a flowchart which illustrates how a communication frame is detected, parsed, and processed to reassemble an IR command code based on the information packet contained in the communication frame.

FIG. 4 is a functional block diagram of one type of device that can be used in implementing some embodiments of the present invention.

FIG. 5 is a functional block diagram showing an example, distributed crosspoint architecture according to some embodiments of the present invention.

FIG. 6 is an example information packet, which describes an IR command code according to some embodiments of the invention.

FIG. 7 is a functional block diagram of a distributed system including a plurality of processor controlled apparatus that can be used to implement some embodiments of the invention.

FIG. 8 is a waveform diagram that illustrates a baseband pattern for an IR command code for a specific manufacturer.

FIG. 9 is another waveform diagram that illustrates a baseband pattern of a command code for a different manufacturer.

FIG. 10 graphically illustrates stored routing information that can be used to implement dynamic routing according to some embodiments of the invention.

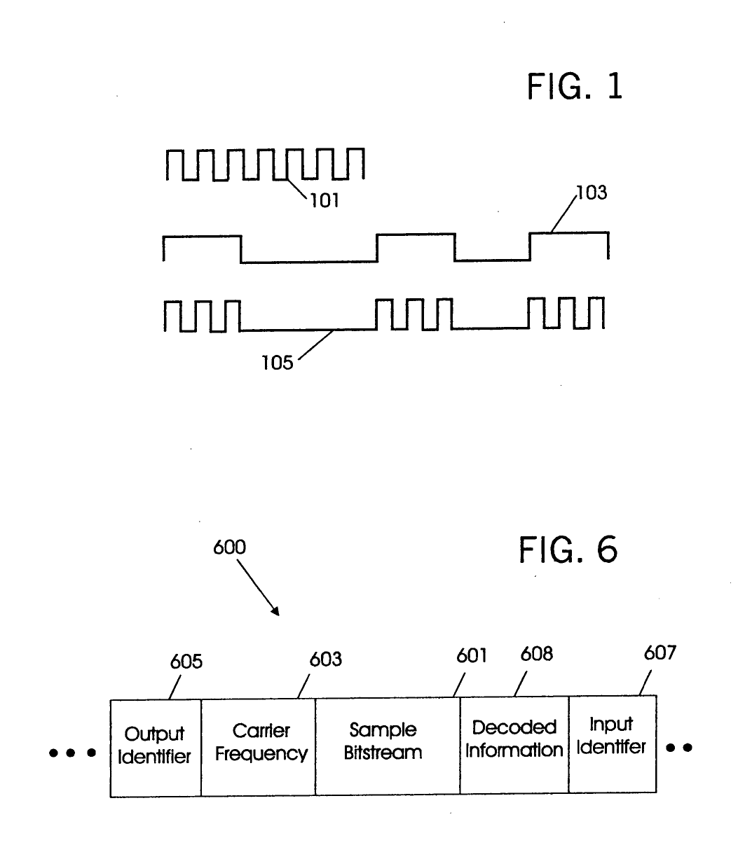

### BEST MODES (S) FOR CARRYING OUT THE INVENTION

The present invention will now be described in terms of specific, example embodiments. It is to be understood that the invention is not limited to the example embodiments disclosed. The meaning of certain terms as used in the context of this disclosure should be understood as follows. The term “infrared command code” and variations such as “IR command” and “IR command code” refer to the modulated stream of pulses that are emitted from a remote control and received by a device to be controlled. Each specific IR command code is intended to cause the device to execute a certain function. The term “packet” and variants such as “information packet” refer to any digital description or digital representation of an IR command code. Such a packet may simply be a sampled command code, or it may be more complex, containing for example, an indication of carrier frequency, and a bit pattern representing an unmodulated command code. A “received packet” is such a packet that is received over a network. A received packet should not be confused with a received IR command code which is received “through the air” from a remote control by an infrared receiver. Likewise, an “outgoing packet” or “outgoing information packet” is one that is sent over a network from a location where an infrared command code was received.

A “baseband pattern” and similar terms such as “baseband code” refer to a pattern of infrared transitions that represents a command emitted by an IR remote control, prior to, or without, any modulation. A “bitstream” is a stream of 1's and 0's that results when a baseband pattern or an IR command code is sampled or “oversampled”. A “communication frame” refers to a frame of information containing addressing information, which is communicated via a network. Typically, such a frame will have an information packet as its payload. The information packet is referred to as being “incorporated” into the communication frame. An example of a communication frame would be an Ethernet frame.

Finally, a “source location” is the location of an IR receiver where the processing takes place to generate the packet discussed above. A “destination location” is the location where the information packet is to be converted back into an IR command code to be emitted by an IR transmitter so that the IR command code may reach the device to be controlled. “Dynamic routing” refers to decisions made in processing packets and command codes as to where to route communication frames containing the packets. These can be based on the content of the IR command code, the baseband pattern, or other information such as at which location the IR command code was received by the crosspoint system. Other terms will either be discussed when introduced, or otherwise should be assumed to have the conventional meaning as understood by persons of ordinary skill in the art.

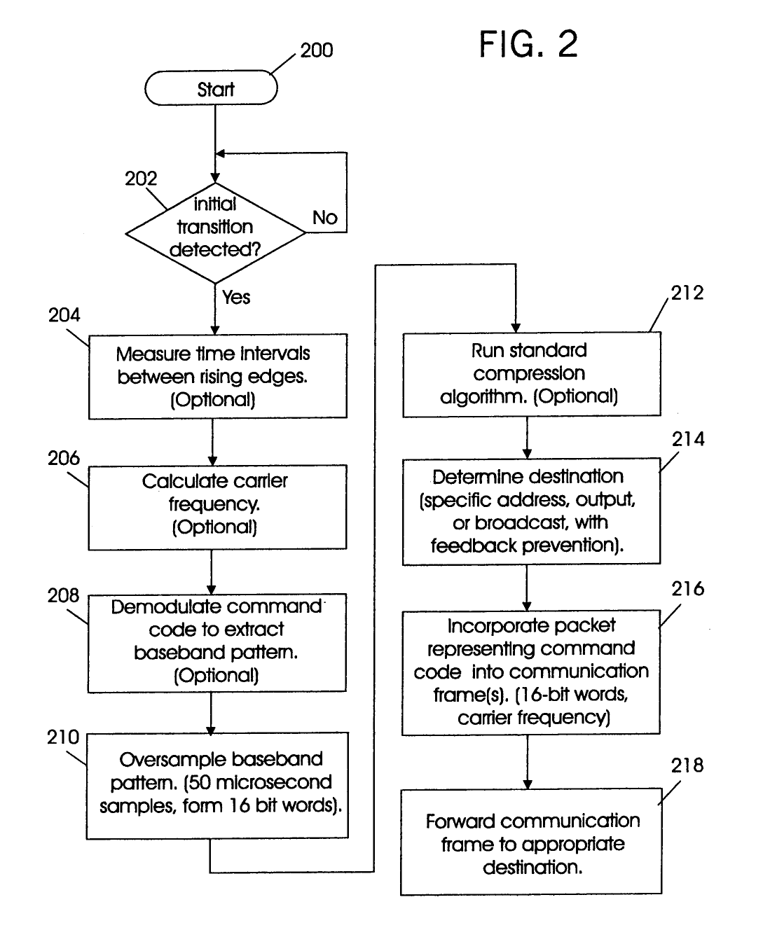

Turning to FIG. 2, the process starts at step 200, typically with the initialization of the hardware. When an initial transition is detected at step 202, the system proceeds to process the IR command code received. In effect, the apparatus at the source location, connected to an IR receiver, is “armed” when the first bit is received by the circuitry. At this point, in one embodiment, the carrier frequency is measured at step 204 and step 206, and the baseband pattern is determined by demodulating the IR command code at step 208. In another embodiment, the oversampling shown at step 210 can be performed on the un-demodulated command code. The latter would of course result in a more extended information packet representing the IR command code, especially if no compression is used.

Returning to the first embodiment, once the transition is detected at 202, two processes begin to take place. The hardware connected to the receiver stores a particular number of raw samples of the IR command code in a frequency determination buffer. A first-in-first-out (FIFO) buffer storing 256 samples works well. Samples that are very short or very long are automatically rejected. At step 204, the frequency determination buffer is emptied, and time intervals between rising edges are measured at step 204. This information can then be readily used to calculate the carrier frequency at step 206. While there will be minor distortions in the outputted signal both in time and modulation frequency, receive circuits for typical home entertainment equipment will be able to receive the IR command code. In fact, the distortion caused by sampling and measurement error is very small compared to actual distortions seen in a typical IR system due to reflections, etc. These steps may also be omitted if an assumption is made about the carrier frequency, for example, in a crosspoint system designed to work with only a single brand of remote controls.

The second process that is initiated in this example after the initial transition is detected is the demodulation of the IR command code to extract the baseband pattern, in step 208. In this case, the baseband pattern is then oversampled at step 210. Within a processor, a field programmable gate array (FPGA) or similar device, incoming bits are shifted into 16-bit words. The sample period can be set to whatever range is needed for the specific application. For example, if commands from a single handheld are all that need to be transported, the sample time can be set using that knowledge. If commands from a variety of manufacturers' devices are intended to be transported through the crosspoint system, the sample time is set to a period that is much smaller than the minimum duration of an IR burst so that a number of samples are taken per bit. For a system that works with all brands of remotes, sampling rates in the range of 50-120 μs work well. A sampling rate of 50 μs results in a sample every two cycles of the carrier, assuming a 40 kHz carrier.

At step 212, the bitstream produced through the oversampling at step 210 can be compressed using a standard compression algorithm. This would be most desirable if the IR command code was sampled without demodulation. At step 214, the processing platform handling the “encoding” of the IR command code can determine a destination where the command code needs to be sent. This step can be as simple as a hardwired decision to repeat the command codes throughout the system, or it can involve complex routing decisions which will be discussed in detail later. At step 216, an information packet representing the IR command code is incorporated into a communication frame. In one embodiment, this information packet contains an indication of the carrier frequency, and a bitstream representing the oversampled baseband pattern. In the case where the IR command code is not demodulated, the indication of the carrier is optional. Other optional information can be included as decoded from the received command, such as the exact manufacturer and key. Receiver identification can also optionally be included for systems that either have multiple receivers on one platform, or systems that do not use network addressing to imply receiver identification. At step 218, the communication frame is forwarded to the appropriate destination in the IR crosspoint system.

The incorporation into a communication frame can be accomplished in a number of ways. Internet protocol (IP) encapsulation can be used in order to take advantage of the fact that Ethernet networks can readily handled IP Ethernet frames. An alternative way to produce a communication frame including the IR command code is to use a media access control (MAC) level frame. The latter requires the definition of a frame type for IR command codes. Ethernet specifies that the first word of a MAC frame defines its type. A MAC frame can be handled more efficiently than an IP frame, since it is handled in the media access layer of the protocol stack, a lower layer, resulting in less complex addressing, error correction, etc.

The process of oversampling as discussed above is a 1 bit sampling process. The process continues until one of two conditions is met. Either the microprocessor or other hardware doing the sampling can stop the process based on the determination that an entire command code has been captured, or the process can be stopped automatically when a number of consecutive samples have had a zero value, indicating no IR energy is present at the IR receiver. If only remotes from a specific manufacturer are to be dealt with, the number of consecutive samples can be set accordingly. For example, with some formats, 32 consecutive samples would be enough. For others, there are long pauses inserted in the baseband pattern as a sync period. In the latter cases, a longer time period of consecutive samples should be used. If this “autostop” feature is not used, software or microcode within the processor or other hardware implementing the invention will stop the process if some number of consecutive, 16 bit words is zero.

The phrase “sampled IR command” or “oversampled IR command” or “sampled IR signal” has a large number of implementation implications. It can refer to an oversampled bitstream of a baseband pattern with optional carrier frequency, or the modulated command code. It can also refer to a compressed bitstream. A compressed bitstream could be one where for a given sample period, the data representing that stream is a succession of numbers representing the number of samples the signal was low, then the number of samples the signal was high, and again the number of sample times the signal was low, and so on. Other data compression schemes can be used. The phrase “sampled IR command” and the like can also refer to the output of software model which may have processed the stream to an even higher level, including but not limited to the manufacturer and codes (such as an “NEC” remote with an 8 bit address and an 8 bit command). The information contained in the sampled IR signal can also contain information needed to configure hardware that might reproduce or transmit the signal. Information such as the sample rate and carrier frequency might be included. Specifying a manufacture, such as “NEC” or “Sony” could also provide this information. The decision on which scheme is used to sample the IR signal is an implementation specific one based on the amount of memory available in the microprocessor, the speed and type of network interface, existing native infrared functions, etc.

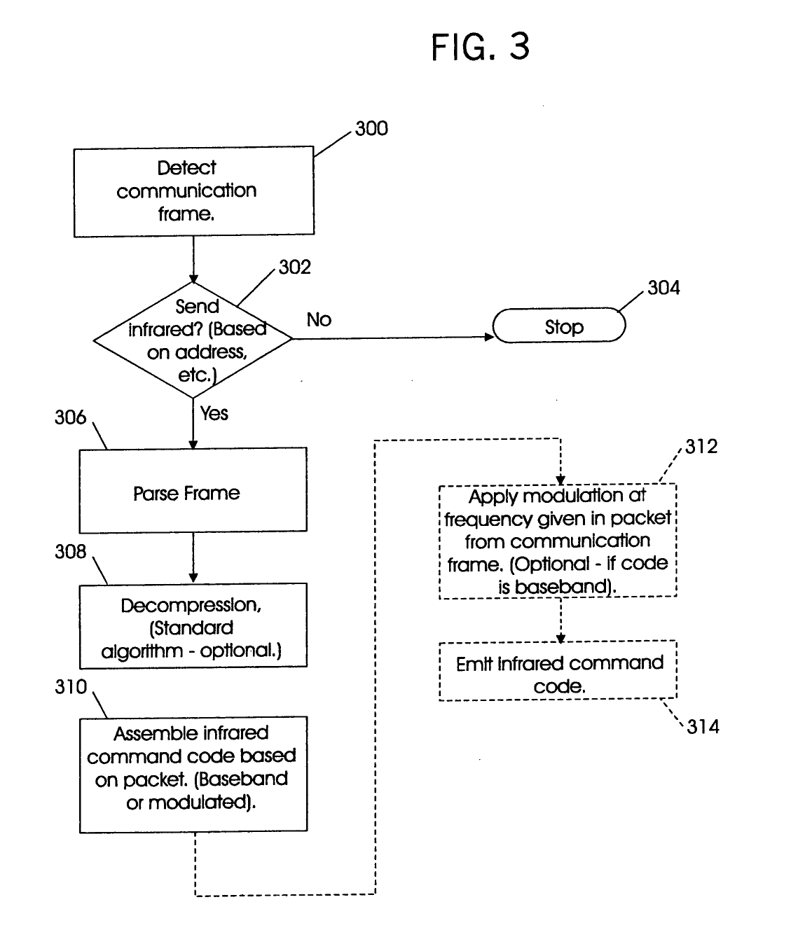

FIG. 3 illustrates how a communication frame containing an information packet describing an IR command code is parsed and processed at a destination location, to be emitted by an infrared transmitter. At step 300 a communication frame is detected on the network. In some embodiments, the communication frame is an Ethernet frame. In step 302 a determination is made as to whether an infrared command code needs to be emitted based on this communication frame. This typically involves the decoding of an address portion of the frame to determine whether it is actually intended for this specific destination location. If not, the process ends at step 304. If so, the frame is parsed at step 306. Parsing simply refers to the act of ascertaining or interpreting the information in the frame. The parsing operation can be very simple, for example where an exact, sampled copy of the IR command code is present, or more complex. Parsing can even be a null action, or simply the copying of digits or values into memory to ascertain the command code. If a compression algorithm is in use, decompression is applied at step 308. It cannot be over emphasized that this step is completely optional. The infrared command code is assembled at step 310. Assembling the command code is simply the inverse of the processing involved in producing the digital description of the command code in the first place. Again, the assembling can be very simple, even a null action or copying or reading digits, or very complex. This may simply involve the recreation of a waveform based on a bit pattern in the information packet. This would be the case, for example, where a modulated IR command code is sampled directly at the source location. However, in the embodiment where the carrier frequency is indicated separately, and the IR command code was demodulated, step 310 includes reading the carrier frequency, assembling the baseband pattern, and modulating the baseband pattern with the carrier frequency. If the device performing the method of FIG. 3 is to emit the IR command code, and where the carrier frequency is indicated, the modulation is applied to the baseband pattern at step 312. This results in an IR command code that is emitted from an IR transmitter at step 314.

It is also possible that a device involved in the process of FIG. 3 is to receive the IR command code over the network in a communication frame and act on it as if it were received from a local remote. In this case, the process of FIG. 3 ends at step 310. In such a case, the command code is simply processed locally, to cause a home entertainment or other device on the net to perform a function via remote control over the network rather than by local IR remote by ascertaining the command code from a communication frame incorporating the code.

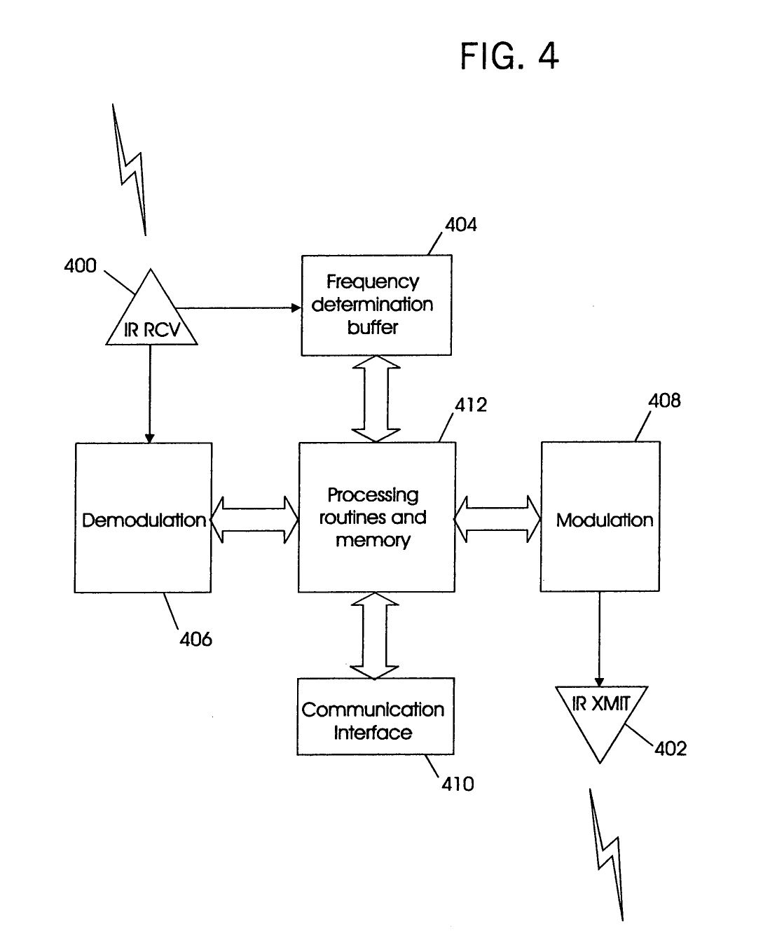

FIG. 4 illustrates one example hardware platform that can be used in implementing the present invention. FIG. 4 shows a standalone “IR unit” which can be used to implement a distributed, infrared crosspoint system according to the invention. FIG. 4 includes an IR receiver, 400, and an IR transmitter, 402. A frequency determination buffer, whose use has been previously described, is shown at 404, operatively connected to the IR receiver. The IR receiver also feeds a demodulation block 406. A modulation block, 408, is connected to IR transmitter 402. Communication interface 410 provides connectivity with a network, such as an Ethernet that is serving the premises in which the crosspoint system is being used.

Processing platform 412 is operatively connected to demodulation block 406, communication interface 410, and the frequency determination buffer, 404. The processing platform consists of processing routines, which are being executed, on a microprocessor or similar device. Memory is also included to store portions of the processing routines, and to store information packets, bitstreams representing baseband patterns or IR command codes, and any other data needed to carry out the function of the device. It should be noted that the configuration illustrated in FIG. 4 is exemplary in nature. The processing platform can be implemented in whole or in part with an FPGA or similar device, or a digital signal processor (DSP) or embedded controller. Separate units may be provided for transmit and receive. In addition, the platform of FIG. 4 can be integrated with other hardware, in which case the processing platform may be shared with other functions, or accessed over a bus.

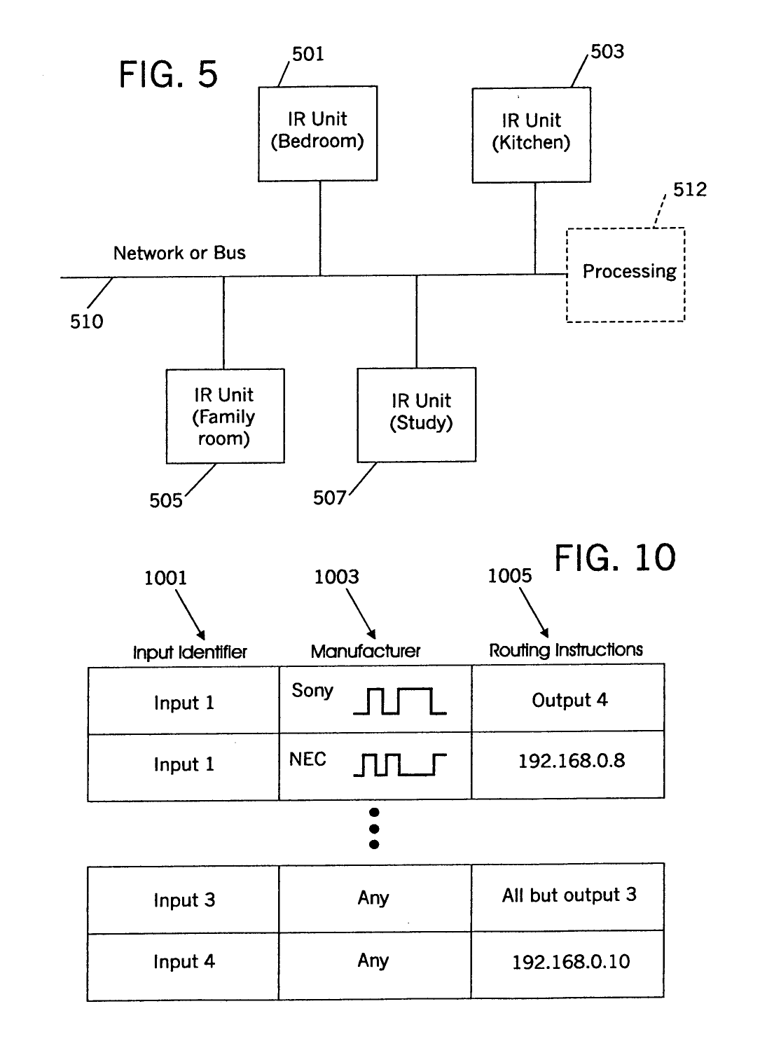

FIG. 5 is a block diagram, which illustrates the overall IR crosspoint system architecture according to some embodiments of the invention. The system in FIG. 5 includes multiple, interconnected, IR units distributed throughout a residence or similar premises. IR unit 501 services a bedroom. IR unit 503 services a kitchen. IR unit 505 services a family room. IR unit 507 services a study. The IR units are interconnected by a network, such as an Ethernet, or a bus, 510. A processing platform, 512, is optionally included.

FIG. 5 can actually be viewed as being representative of a number of alternative embodiments of the system. If network 510 is a general purpose computer or communication network such as an Ethernet, each IR unit contains hardware similar to that illustrated in FIG. 4. Each IR unit could contain an IR transmitter, an IR receiver, or both. Information packets describing IR command codes are encapsulated in communication frames such as Ethernet frames in this case. It should also be noted that each IR unit could actually be combined with or included in other devices that have a network interface. Many common home entertainment devices already contain infrared capability. Some devices, for example high-end home satellite receivers, have both receive and transmit functions, the transmit function being used to control adjacent devices such as a VCR. The IR functions of the present invention could be combined with telephone devices, audio/video entertainment devices such as an analog or digital video recorder or a so-called “personal video recorder” or PVR, or even an appliance or HVAC control device. It is also possible that the processing platform, 512, is an intelligent, home device such as the PVR or any other device, that can, among other things, receive the communication frame according to the invention over the network and act on it. The device treats the information packet in the frame as if it were an IR command code received “over-the-air” from a local remote, and performs the corresponding function. Any of the formats for the packet and communication frame discussed can be used, although, if device specific Ethernet or IP addressing is used, only the baseband pattern actually needs to be sent, since the device knows the pattern is intended for it. Such a device would probably include a complete set of IR hardware as shown in FIG. 4, but would only have to include the communication interface and the processing platform executing the appropriate processing routines. In many cases these processing routines are stored in the form of computer program code such as “microcode” or in the form of a programmed, semiconductor device.

An alternative embodiment of a crosspoint system is also illustrated by FIG. 5. In this embodiment, the IR crosspoint system is self-contained in a single unit. The IR units of FIG. 5 actually represent connections to local or remote IR receivers and/or transmitters. Signals coming from source locations are communicated over bus 510 to either the processing platform of the device, as shown at 512, or to other IR connections. For example, each IR unit shown in FIG. 5 may represent an interface to an RF, or wired signaling path, which leads to wall-mounted IR transmitters/receivers in various rooms. In this case, an information packet describing an IR command code is not communicated via a network, but is either communicated over the internal bus or simply stored in the processing platform, 512, for processing. Although IR signals in the latter case are not sent in an efficient packet format around the premises, this alternate embodiment still allows for the dynamic routing which is also characteristic of the invention. Again, dynamic routing is described in more detail near the end of this disclosure.

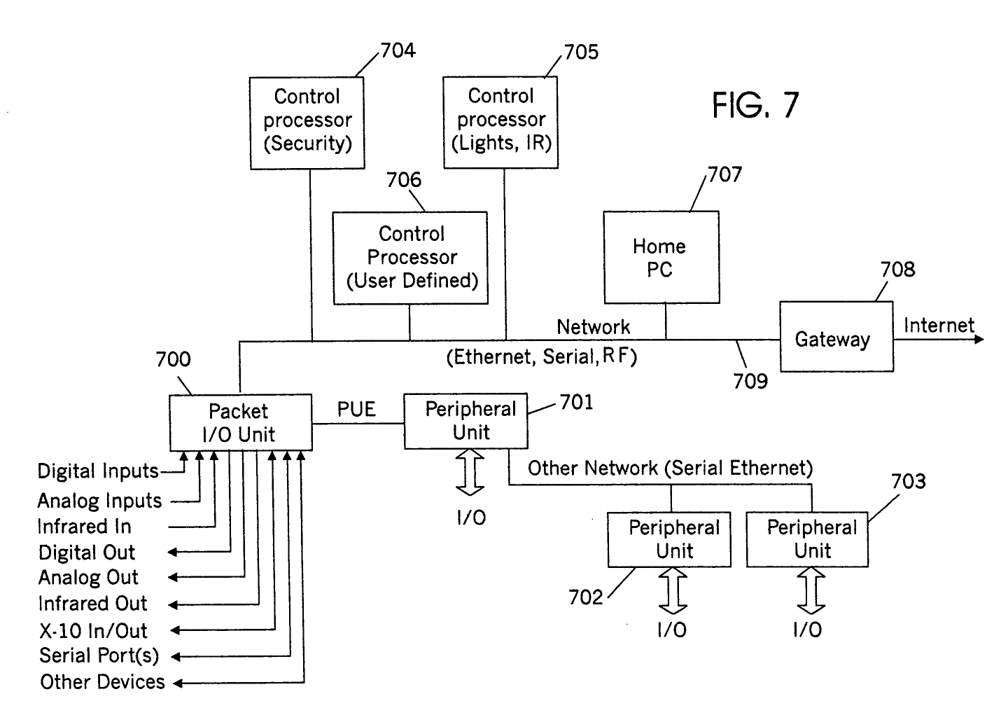

FIG. 6 illustrates an information packet, 600, according to some embodiments of the invention. The ellipsis dots shown in FIG. 6 illustrate where other parts of a communication frame would be located, such as routing and addressing information according to the various layers of the open system interconnect (OSI) model. The bitstream of samples representing an IR command code is shown at 601. All other fields are optional. If the IR command code were not demodulated, but simply sampled at a high rate and possibly compressed to produce the bitstream, this might be all that is present in the packet. In some of the embodiments discussed however, where the command code has been demodulated, sample bitstream 601 would simply represent the baseband pattern. In this case, an indication of carrier frequency is included at 603. Output identifier 605 and input identifier 607 are also optional. These might be included to identify specific IR inputs and outputs in a system where more than one input and/or output is associated with a network address. These fields can be used in some embodiments of the dynamic routing. Additionally, they can be formatted to identify any one of many distributed inputs and/or outputs in a premises automation system as is described with reference to FIG. 7. Optional field 608 includes information optionally decoded from the IR command code, such as manufacturer, keystroke, etc., as previously described.

FIG. 7 is a network level block diagram showing a premises automation system that can be used to implement the crosspoint according to the invention. The system of FIG. 7 is fairly large; however, it is shown by way of example only. A system incorporating the invention can be much smaller, even consisting of one I/O unit. This system is comprised of multiple I/O units, 700, 701, 702, and 703. An example of the connective topology, used by this example implementation, is packet I/O unit 700 that is connected to a home network, 709, (for example, an Ethernet) including control processor or software program 704 for a security system, control processor or software program 705 which provides lighting and infrared device control, and control processor or software program 706, which is userdefined. A home personal computer, 707, and Internet gateway 708 can also be connected to this network, and are shown in this example. The gateway to the Internet, 708 of FIG. 7 is included for facilitating transmission of Email or other types of messages or packets over the Internet if a notification of an event needs to be communicated outside the premises.

The additional I/O units are connected to unit 700 via a specialized type of serial port on units 700 and 701, which is called herein a “peripheral unit expansion” (PUE) interface, to be described in detail later. The PUE electrical interface in the example embodiments shown is similar to an “RS-485” port, but may take other forms. Additional units 702 and 703 are connected to unit 701 through a second home network for example, another Ethernet leg, although they could also be connected through the PUE interface. Units connected through the PUE interface are typically smaller in size, cost, and capability, and are thus referred to as “peripheral I/O units” or simply “peripheral units,” not to be confused with the term “peripheral” as applied to computer peripherals. The serial type PUE interface is slower than many types of network connections, such as Ethernet, but this slower speed is acceptable because of the smaller data bandwidths of the peripheral units.

Each I/O unit has a number of different devices that can connect to its inputs and outputs. Some devices, such as switches and relay contact closures, require little processing. Others, such as analog voltages that represent temperatures, will require a little more processing. And some, such as serial ports and infrared I/O for implementing the present invention will require still more processing. Some of these inputs and outputs are illustrated in FIG. 7 as connected to packet I/O unit 700. These include digital inputs and outputs, analog inputs and outputs, the infrared inputs and outputs, X-10 ports, and serial ports. The peripheral I/O units have similar types of I/O, but specific inputs and outputs are not shown for clarity.

At this point, it is useful to discuss the input and output identifier system or addressing scheme used in the system of FIG. 7. This scheme enables inputs and outputs throughout the premises automation system to be treated as a large collection of what is referred to herein as distributed inputs and outputs, meaning inputs and outputs that are spread across multiple I/O units. Each I/O unit in the system has a unique unit number so that all the I/O in the system can be uniquely addressed. Furthermore each input on an I/O unit with a particular unit number has a unique input number within that I/O unit. Likewise, each output on an I/O unit with a particular unit number has a unique output number within that I/O unit. In this way, an input can be addressed with a combination of unit number/input number, and an output can be addressed with a combination unit number/output number. Thus, all “things” manipulated by the system have a unique identifier, including, potentially, IR command codes. The unique identifier has a format that consists of at least two pieces, a unit number and an input/output number. The unit number is used much like a subnet mask in Internet protocol during routing. It assists in the routing of packets to I/O units. These numbers are unique system wide. The control of a collection of units can be executed via multiple pieces of software that may reside on multiple processing platforms and that use these unique numbers. Infrared inputs and outputs used to implement the invention have input and output identifiers that follow the above scheme. These can be inserted into the information packet shown in FIG. 6 as previously discussed. The premises automation system of FIG. 7 is described in further detail in U.S. patent application Ser. No. 10/068,157, filed on Feb. 6, 2002 by the inventor hereof, which is incorporated herein by reference.

At least one of the I/O units shown in FIG. 7 has hardware and software that implement both a local and a networked infrared (IR) crosspoint and routing functions. The hardware on the box consists of a simple 5-in to 5-out crosspoint and separate transmit and receive circuitry implemented in an FPGA. The inputs to the 5-in crosspoint are four external inputs from IR receivers such as the Dinky-Link™ and the output of the on board transmitter. The outputs from the 5-out crosspoint are four external outputs which will have IR transmit LED's on them, and the onboard receiver. The crosspoint is a real-time router, which switches the entire signal, carrier modulation and all by converting it to information packets stored in memory as previously discussed. Registers associated with each output specify which of the inputs connect to that output. The registers are five bits in length, with a bit per possible input.

The IR transmitter takes a stream of bits written as 16 bit words and serially outputs those bits. The period per bit is set in a register in the FPGA, and can be a wide range from 250 ns to 500 μs per bit. Typical values used are between 50 and 280 μs. A one in the bitstream means that the IR LED will be on. There is also a carrier modulation device on the FPGA, which can modulate the bitstream. It can be set to run at a frequency from 15 kHz to 250 kHz. The particular implementation on the FPGA also has a 256 word FIFO to reduce interrupt latency requirements. An additional 256 byte FIFO stores the 1^{st} 256 carrier frequency samples.

Once an I/O unit has received an IR burst from a handheld via its receiver, it has a sampled IR signal. As already described the sampled IR command code is a collection of data that is sufficient in detail to allow reconstruction of the original IR command. Software tables can be used to determine the routing of the sampled signal, and the network then used to send the data to the various units that will regenerate and transmit the burst. These tables are logically similar to the small hardware crosspoint switch in the I/O unit. The tables are comprised of a list of inputs that need to route to a given output. In other words, there is a list associated with each output that says which inputs drive the output. Note that due to the symmetry of the crosspoint, this list can be stored in a reverse order, namely there can be a list associated with each input that is a list of outputs to which input data should be sent. It should be clear that this information could be factored out in various ways that all achieve the same end result. These tables can be full or sparse as long as the routing decisions can be made. Note also that a system can contain a mixture of local crosspoints and network crosspoints. It can also be as simple as a two-node system, or a 1×1 crosspoint either local to a unit or over a network.

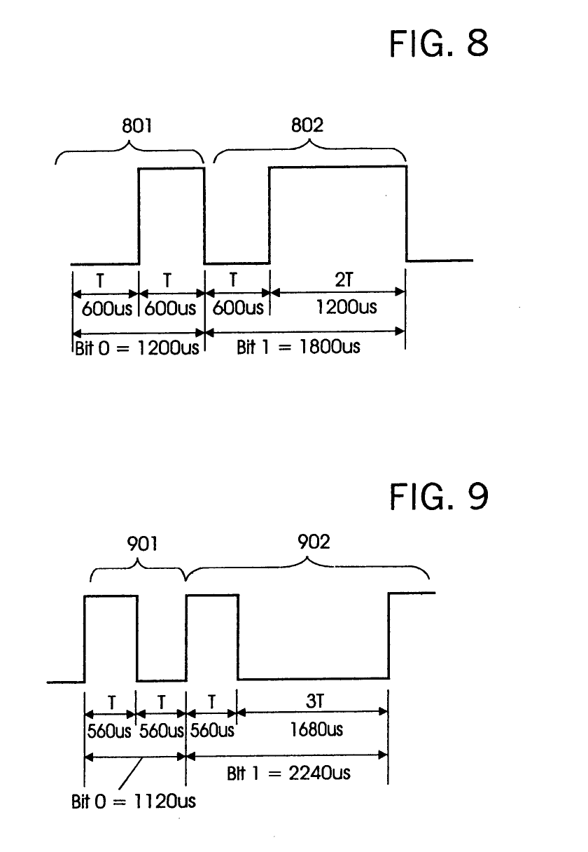

FIGS. 8 and 9 illustrate baseband patterns used by certain remote controls. FIG. 8 illustrates the type of pattern used by many remotes for equipment manufactured by the Sony Corporation. FIG. 9 illustrates a baseband pattern that is common in equipment of various Japanese manufacturers, including Nippon Electric Company (NEC), Hitachi, and Pioneer. It should be noted that in addition to working as a network IR crosspoint system as previously described, the invention can be used to enable dynamic routing of IR command codes. Dynamic routing is to be contrasted with static routing in that static routing involves sending IR command codes to the same place regardless of the content of the command codes. Using dynamic routing, each IR burst received is decoded and compared to templates that are stored in memory or processed using software and then looked up in a table. Using these templates, information can be extracted from the IR command code such as the manufacturer, the type of device the command code is targeted to (DVD, VCR, television), an address, a repeat burst, or the specific command. The specific channel, or IR receiver, on which the command code was received can also be used in dynamic routing. In any case, dynamic routing is accomplished by referring to stored routing information, which will be discussed with reference to FIG. 10.

The differences between the two examples given in FIGS. 8 and 9 will highlight to those of ordinary skill in the are how to design templates which can be used to ascertain, for example, the manufacturer of the device and remote control in question. The Sony baseband pattern of FIG. 8 uses a bit-width codification. The basic unit of time, T, is 600 μs long. Each transmitted bit is composed of a period of −T+T for bit 0 or −T+2T for bit 1. Thus bit 0, shown at 801, has a length of 1200 μs. Bit 1, shown at 802, has a length of 1800 μs. The uplevel essentially means that infrared is being transmitted while a downlevel means silence. Of course, as previously described, this baseband pattern is modulated. In the case of Sony, a modulation frequency of 36 kHz is used.

FIG. 9 illustrates a baseband pattern format which also uses bit-width, but uses different time periods than the baseband pattern shown in FIG. 8. In this case, the time T is 560 μs. Another difference is that bit 0 is transmitted by a +T−T pattern (the opposite of that shown in FIG. 8) and bit 1 is transmitted by a +T−3T pattern. The bit 0 pattern is shown at 901, and the bit 1 pattern is shown at 902. In this case, bit 0 has a length of 1120 μs while bit 1 has a length of 2240 μs. Bit width codification is common in systems made by Japanese manufacturers, and so it is quite common in home entertainment equipment in general. However, other baseband pattern codification schemes are in use, including pulse position codification and codification based on the number of pulses received in a specific time interval.

FIG. 10 illustrates one possible way of implementing stored routing information that is used in the dynamic routing which can be implemented as part of the present invention. Dynamic routing can be used in a stand-alone IR system, or it can be combined with the normal routing of a more comprehensive premises automation system such as that described relative in FIG. 7. It must be emphasized that FIG. 10 is a graphical construct that shows one possible routing information mechanism. The possibilities for designing a routing reference to be stored internally in an IR crosspoint system are almost infinite. FIG. 10 is a table with many entries. Only four entries (rows) are shown for clarity. The first column of the table specifies an input identifier as shown at 1001. The second column of the table, 1003, stores information related to a manufacturer. As previously discussed, the manufacturer for equipment associated with an IR command code is determined by comparison to baseband pattern templates. Additional and optional information, such as the keystroke or a list of keystrokes can be in another column of the table. Column 1005 of the table shown in FIG. 10 shows routing instructions.

The input identifier in a specific entry can literally be the name of an input in a device in which inputs are local to the processing platform that is performing the routing. Alternatively, if the dynamic routing is implemented in a system using hardware platforms like that shown in FIG. 4, the input identifier could be an IP or Ethernet address. The IP address would be the IP address of the platform containing the IR receiver that corresponds to the input. If the invention were implemented in a distributed, packet-based, premises automation system like that shown in FIG. 7, the input identifier could be formatted to identify a distributed input from among a plurality of distributed inputs.

Likewise, the routing instructions contained in column 1005 can specify a local output, all outputs, all outputs except for a specific output, or a network address which might correspond to a hardware platform having an IR transmitter which is remote from the processing platform making the routing decisions. All of these examples are shown in FIG. 10. In the third entry of the table of FIG. 10, routing is to “all but output 3 ”. Note that in this case, the IR command code was received at input 3. It is assumed for the purposes of this disclosure that input 3 and output 3 are located in the same room. Thus, it is desirable even in the case where routing is to all other outputs of the system, to inhibit routing to the local output. This type of routing can be used to prevent lock-ups. The input can be indicated by a hardware register in the platform, which is performing the routing. For example, in the system of FIG. 7, there is a register which shows which of the external IR inputs into the local processing platform has had activity, as previously discussed. The room which is being serviced by that platform would be excluded from re-transmitting the signal, even if the signal was intended to be transmitted to all distributed outputs in the system. In normal use, an IR input and output in the same room would not be routed through the crosspoint. For example, anything received in the master bedroom would not be routed into the master bedroom since the system would latch up on any IR command code. Note that in a case where a single transmitter is associated with a specific IP address, the IP or Ethernet address is all that is needed. This is the example shown in rows 2 and 4 of the table of FIG. 10.

The dynamic routing just discussed can be integrated with the normal routing functions of the I/O units discussed with respect to FIG. 7, or the routing functions of any known home or premises automation system. Typically, each transmit and receive in the system has a unique number. A variety of schemes may be employed to access a given port on the crosspoint, and resolve it down to a physical port on a given box attached to the network. For example, an identifier can be unique number comprised of a unit number concatenated with an input or output number. In the case of an I/O unit where the internal crosspoint is a 5×5, 3 bits could be allocated for the unit-specific crosspoint number. An additional 8 bits could be allocated for the unit number. In a slightly different system, the unit could also be referred to by its IP address. A block of UDP port numbers could be reserved for the local channel numbers. Another scheme that can be used in a comprehensive home automation system involves a simple table that takes an I/O number and allows a lookup process to determine the unit number on the network, and the local port number on that unit. The concept of resolving a logical system resource number to a specific unit and I/O or process or port number is well known in networking systems. Using a system of hardware, system routing tables, network connectivity, and possibly local crosspoint switches, a network crosspoint switch and router that makes use of the principles of the invention can be constructed. Such a system allows IR burst from handheld devices to be routed to any possible configuration of outputs on a number of boxes on a network.

It is also possible to use the principles of the invention to receive an IR command code and process the code in software, and then either route the original sampled IR command code, or in response to user configuration options, substitute (or map to) a different IR command code. The new code is then routed to a destination for emission. This functionality would implement a universal remote using extremely low cost remotes, the network IR crosspoint, and processing which does the IR analysis and then uses the network IR crosspoint to route the mapped burst to the correct receive sites. The IR command can be said to be in a “source format” at the source location, and in a “destination format” (possibly for a different manufacturer's equipment) at a destination location. Dynamic routing also includes time and processing delays, and therefore affords other processing opportunities before transmission over the network of the sampled IR command code such as burst mapping (or keystroke mapping), repeat code substitution, and context sensitive routing decisions.

As previously described, it is also possible that a device is part of a crosspoint system, where the device would not retransmit the IR signal if that device were capable of performing the function indicated by the IR stream. For example, a PVR that received a play command would not broadcast that command out into the local room, but would instead perform the function of playing the (presumably) selected digital recording.

Specific embodiments of an invention are disclosed herein. One of ordinary skill in the networking and remote control arts will quickly recognize that the invention has other applications in other environments. In fact, many embodiments and implementations are possible. The following claims are in now way intended to limit the scope of the invention to the specific embodiments described above.

I claim:

1. A method of transferring an infrared (IR) command code from an IR receiver at a source location to an IR transmitter at a destination location, the method comprising the steps of:
receiving the IR command code at the source location;
processing the IR command code to produce a packet representing the IR command code;
incorporating the packet into a communication frame;
forwarding the communication frame over a network to the destination location;
parsing the communication frame at the destination location;
assembling the IR command code based on the packet from the communication frame; and
emitting the IR command code from the IR transmitter at the destination location.

2. The method of claim 1 wherein the processing step further comprises the steps of:
demodulating the IR command code to produce a baseband pattern; and
oversampling the baseband pattern to produce a bitstream.

3. The method of claim 2 wherein the processing step further comprises the steps of:
extracting a carrier frequency from the IR command code; and
combining an indication of the carrier frequency and the bitstream to form the packet.

4. The method of claim 1 wherein the forwarding step further comprises the step of determining the destination location dynamically.

5. The method of claim 4 wherein the step of determining the destination location dynamically is accomplished through extracting information from IR command code.

6. The method of claim 3 wherein the forwarding step further comprises the step of determining the destination location dynamically.

7. The method of claim 6 wherein the step of determining the destination location dynamically is accomplished through extracting information from IR command code.

8. The method of claim 1 wherein the processing step further comprises applying a compression algorithm.

9. The method of claim 3 wherein the processing step further comprises applying a compression algorithm to the bitstream.

10. The method of claim 1 wherein the communication frame is an Ethernet frame.

11. The method of claim 3 wherein the communication frame is an Ethernet frame.

12. The method of claim 5 wherein the communication frame is an Ethernet frame.

13. The method of claim 8 wherein the communication frame is an Ethernet frame.

14. The method of claim 9 wherein the communication frame is an Ethernet frame.

15. A method of dynamically routing infrared (IR) command codes to IR transmitters at destination locations, the method comprising the steps of:
receiving IR command codes through an IR receiver at a source location;
independently determining, for each IR command code, based at least in part on stored routing information, the destination location for the IR command code from among a plurality of destination locations; and
emitting the IR command codes from the IR transmitters at the destination locations.

16. The method of claim 15, further comprising the steps of, for each IR command code:
demodulating the IR command code to produce a baseband pattern; and
oversampling the baseband pattern to produce a bitstream, which at least in part forms an information packet representing the IR command code, wherein the information packet is forwarded to a destination location.

17. The method of claim 16, further comprising, for each IR command code:
extracting a carrier frequency from the IR command code; and
combining an indication of the carrier frequency and the bitstream to form a packet.

18. The method of claim 15 wherein the stored routing information comprises manufacturer information.

19. The method of claim 16 wherein the stored routing information comprises manufacturer information.

20. The method of claim 15 wherein the stored routing information includes source location information.

21. The method of claim 20 wherein the source location information is used to inhibit routing to the source location.

22. The method of claim 16 wherein the stored routing information includes source location information.

23. The method of claim 22 wherein the source location information is used to inhibit routing to the source location.

24. The method of claim 15 wherein the IR command code is in a source format when received at the source location, and wherein the independently determining step further comprises determining a destination format and further comprising the step of, for each IR command code, mapping the IR command code from the source format to the destination format.

25. Apparatus for transferring an infrared (IR) command code from an IR receiver at a source location to an IR transmitter at a destination location, the apparatus comprising:
means for receiving the IR command code at the source location;
means for processing the IR command code to produce a packet representing the IR command code;
means for incorporating the packet into a communication frame;
means for forwarding the communication frame over a network to the destination location;
means for parsing the communication frame at the destination location;
means for assembling the IR command code based on the packet from the communication frame; and
means for emitting the IR command code from the IR transmitter at the destination location.

26. The apparatus of claim 25 wherein the means for processing further comprises:
means for demodulating the IR command code to produce a baseband pattern; and
means for oversampling the baseband pattern to produce a bitstream.

27. The apparatus of claim 26 wherein the means for processing further comprises:
means for extracting a carrier frequency from the IR command code; and
means for combining an indication of the carrier frequency and the bitstream to form the packet.

28. Apparatus for dynamically routing infrared (IR) command codes to IR transmitters at destination locations, the apparatus comprising:
means for receiving IR command codes through an IR receiver at a source location;
means for independently determining, for each IR command code, the destination location for the IR command code from among a plurality of destination locations; and
means for emitting the IR command codes from the IR transmitters at the destination locations.

29. The apparatus of claim 28 wherein the means for processing further comprises:
means for demodulating the IR command code to produce a baseband pattern; and
means for oversampling the baseband pattern to produce a bitstream, which at least in part forms an information packet.

30. The apparatus of claim 29 wherein the means for processing further comprises:
means for extracting a carrier frequency from the IR command code; and
means for combining an indication of the carrier frequency and the bitstream to form the packet.

31. The apparatus of claim 28 wherein the means for independently determining comprises stored routing information.

32. The apparatus of claim 31 wherein the stored routing information includes manufacturer information.

33. The apparatus of claim 29 wherein the means for independently determining comprises stored routing information.

34. The apparatus of claim 33 wherein the stored routing information includes manufacturer information.

35. The apparatus of claim 28 wherein the IR command code is in a source format when received at the source location, and wherein the means for independently determining further comprises means for determining a destination format and wherein the apparatus further comprises means for mapping the IR command code from the source format to the destination format.

36. An Ethernet frame comprising a digital representation of infrared (IR) command code.

37. The Ethernet frame of claim 36 further comprising an indication of a carrier frequency.

38. The Ethernet frame of claim 36 further comprising input identifier.

39. The Ethernet frame of claim 37 further comprising an input identifier.

40. The Ethernet frame of claim 38 further comprising an output identifier.

41. The Ethernet frame of claim 39 further comprising an output identifier.

42. The Ethernet frame of claim 36 wherein the Ethernet frame is a media access control (MAC) level frame.

43. The Ethernet frame of claim 37 wherein the Ethernet frame is an internet protocol (IP) frame.

44. Apparatus for digitally forwarding an infrared (IR) command code, the apparatus comprising:
an IR receiver;
a communication interface; and
a processing platform operatively connected to the communication interface and the IR receiver, the processing platform operative to control the apparatus to process a received IR command code to produce an information packet representing the IR command code, and to forward the information packet over the communication interface.

45. The apparatus of claim 44 wherein the communication interface is an Ethernet interface.

46. The apparatus of claim 44 wherein the communication interface is an internal bus interface.

47. The apparatus of claim 45 wherein the information packet is dynamically routed to a destination determined at least in part from stored information.

48. The apparatus of claim 46 wherein the information packet is dynamically routed to a destination determined at least in part from stored information.

49. The apparatus of claim 44 further comprising a frequency determination buffer operatively connected to the processing platform and the IR receiver.

50. The apparatus of claim 45 further comprising:
a frequency determination buffer operatively connected to the processing platform and the IR receiver; and
a demodulation block operatively connected to the processing platform and the IR receiver.

51. Apparatus for assembling and emitting an infrared (IR) command code based on contents of a received information packet, the apparatus comprising:
an IR transmitter;
a communication interface; and
a processing platform operatively connected to the communication interface and the IR transmitter, the processing platform operative to control the apparatus to assemble the IR command code based on a received information packet, and cause the IR transmitter to emit the IR command code.

52. The apparatus of claim 51 further comprising:
an IR receiver; and
wherein the processing platform is further operable to control the apparatus to produce outgoing information packets describing IR command codes and to send outgoing information packets over the communication interface.

53. The apparatus of claim 51 wherein the communication interface is an Ethernet interface.

54. The apparatus of claim 51 wherein the communication interface is an internal bus interface.

55. The apparatus of claim 52 wherein the communication interface is an Ethernet interface.

56. The apparatus of claim 52 wherein the communication interface is an internal bus interface.

57. A distributed system comprising a plurality of processor controlled apparatus, at least some of the processor controlled apparatus operable to transfer an infrared (IR) command code from an IR receiver at a source location to an IR transmitter at a destination location, by performing the steps of:
receiving the IR command code at the source location;
processing the IR command code to produce a packet representing the IR command code;
encapsulating the packet into a communication frame;
forwarding the communication frame over a network to the destination location;
parsing the communication frame at the destination location;
assembling the IR command code based on the packet from the communication frame; and
emitting the IR command code from the IR transmitter at the destination location.

58. The system of claim 57 wherein the destination location can be determined dynamically.

59. The system of claim 58 wherein determination of the destination location dynamically is accomplished through extracting information from the IR command code.

60. The system of claim 57 wherein the communication frame is an Ethernet frame.

61. The system of claim 58 wherein the communication frame is an Ethernet frame.

62. The system of claim 59 wherein the communication frame is an Ethernet frame.

63. A method of responding to an infrared (IR) command code comprising the steps of:
receiving a communication frame over a network, the communication frame incorporating a digital representation of the IR command code;
parsing the communication frame to ascertain the IR command code; and
performing a function corresponding to the IR command code.

64. The method of claim 63 wherein the communication frame is an Ethernet frame and the network is an Ethernet network.

65. The method of claim 64 wherein the Ethernet frame is a media access control (MAC) level frame.

66. The method of claim 64 wherein the Ethernet frame is an internet protocol (IP) frame.

67. Apparatus for responding to an infrared (IR) command code, the apparatus comprising:
means for receiving a communication frame over a network, the communication frame incorporating a digital representation of the IR command code;
means for parsing the communication frame to ascertain the IR command code; and
means for performing a function corresponding to the IR command code.

68. The apparatus of claim 67 wherein the communication frame is an Ethernet frame and the network is an Ethernet network.

69. The apparatus of claim 68 wherein the Ethernet frame is a media access control (MAC) level frame.

70. The apparatus of claim 68 wherein the Ethernet frame is an internet protocol (IP) frame.

71. Apparatus for responding to an infrared (IR) command code, the apparatus comprising:
a communication interface; and
a processing platform operatively connected to the communication interface, the processing platform operative to control the apparatus to receiving a communication frame over a network, the communication frame incorporating a digital representation of the IR command code, parse the communication frame to ascertain the IR command code, and perform a function corresponding to the IR command code.

72. The apparatus of claim 71 wherein the communication frame is an Ethernet frame and the network is an Ethernet network.

73. The apparatus of claim 72 wherein the Ethernet frame is a media access control (MAC) level frame.

74. The apparatus of claim 72 wherein the Ethernet frame is an internet protocol (IP) frame.
